(19) United States
(12) Patent Application Publication
(10) Pub. No.: US 2013/0227650 A1
(43) Pub. Date: Aug. 29, 2013

(54) Vehicle-Mounted Network System

(71) Applicant: Junji Miyake, Hitachinaka (JP)

(72) Inventor: Junji Miyake, Hitachinaka (JP)

(73) Assignee: Hitachi Automotive Systems ,Ltd., Hitachinaka-shi ,Ibaraki (JP)

(21) Appl. No.: 13/882,617

(22) PCT Filed: Nov. 4, 2011
(86) PCT No.: PCT/JP2011/075393

§ 371 Date: Apr. 30, 2013

(30) Foreign Application Priority Data
Nov. 12, 2010 (JP) 2010-254123

(51) Int. Cl. H04L 29/06

(52) U.S. Cl. CPC H04L 63/08
USPC 726/3

(57) ABSTRACT

Provided is a method capable of enhancing security of a vehicle-mounted network while reducing processing loads in each vehicle-mounted control device.

In a vehicle-mounted network system according to the present invention, a communication device issuing a read request or a write request on data held in the vehicle-mounted control device is previously authenticated by an authentication device (see FIG. 1).

### TECHNICAL FIELD

The present invention relates to a vehicle-mounted network system.

### BACKGROUND ART

In recent years, vehicle-mounted ECUs (Electronic Control Unit) for controlling each function unit are mounted on cars, trucks, and buses. The respective ECUs are mutually connected to each other via a vehicle-mounted network to operate in cooperation.

Each ECU performs a step called calibration, adaptation or matching in its development phase. In the step, control parameters are monitored from the outside of the ECU, and control constants referenced by an internal program are changed and written back to each ECU to be set.

Other than in the development phase, software may be rewritten on recall or service campaign after the shipment of the vehicles. This indicates that, when a failure of the control program is found after manufactures are shipped to market, the program of the vehicle-mounted ECUs is rewritten after dealers recall the vehicles.

The control parameters are adjusted or the program is rewritten from the outside of the vehicle-mounted ECU via a vehicle-mounted network such as CAN (Controller Area Network) or FlexRay. At this time, a dedicated rewrite terminal is connected to the vehicle-mounted network, or an out-vehicle communication network such as Internet and the vehicle-mounted network are electrically connected to each other for the rewrite work. At this time, for eliminating unauthorized rewrite, it is necessary to authenticate whether the rewrite terminal or a device which is connected to the vehicle-mounted network to issue a rewrite instruction is approved.

Typically, the control program of the vehicle-mounted ECU is stored in a storage device such as flash ROM (Read Only Memory) in an incorporated microcomputer. In order to rewrite the program, all the stored data in the region containing the old program is temporarily erased physically, and then a new program needs to be written into this initialized area.

When the rewrite terminal or the like is malicious, the old program in the ECU is erased and a new program is not transferred, thereby easily stopping the function of the ECU. The function is stopped, and additionally the program may be rewritten to a new malicious program. Thereby, a program which intentionally causes behaviors unsafe for control may be installed. Further, a problem can be caused in other than the ECU to be rewritten. For example, a program which intentionally saturates communication traffic of the vehicle-mounted network may be installed. Additionally, the information that a specific ECU failed is delivered to the vehicle-mounted network thereby to let other normal ECUs work on intentional fail-safe operation.

The program rewrite has been described above, but additionally, a function for confirming variables inside the ECU may be misused in the development phase, and data inside the ECU may be illegally acquired. For example, the control parameters of a specific ECU may be illegally monitored via the vehicle-mounted network, and reverse engineering may be performed based on the monitoring result thereby to collect technical information on the ECU, or personal information may be acquired from information system ECUs such as car navigation, ETC (Electronic Toll Collection), and cell phone.

PTL 1 described later discloses, as a technique for protecting a vehicle-mounted network and ECUs configuring the network from the malicious terminal described above, a method in which an ECU communicating with an external terminal individually authenticates a party terminal thereby to eliminate unauthorized invasion via the vehicle-mounted network.

### CITATION LIST

### Patent Literature

PTL 1: JP 2010-23556 A

### SUMMARY OF INVENTION

### Technical Problem

In a case such as traffic saturation attack in a vehicle-mounted network, the security of the entire vehicle-mounted network depends on an ECU with the most vulnerable security. Thus, even if an individual ECU enhances its security, the security of the entire vehicle-mounted network cannot be enhanced due to other vulnerable ECUs.

However, about the vehicle-mounted ECU, the computation capability of the mounted microcomputer or a resource such as ROM/RAM (Random Access Memory) are relatively low functions, and thus it is difficult to employ an advanced authentication algorithm.

The present invention has been made in order to solve the above problems, and an object of the present invention is to provide a method capable of enhancing security of a vehicle-mounted network while reducing processing loads of each vehicle-mounted control device.

### Solution to Problem

In a vehicle-mounted network system according to the present invention, a communication device for issuing a read request or a write request on data held in a vehicle-mounted control device is previously authenticated by an authentication device.

### Advantageous Effects of Invention

With the vehicle-mounted network system according to the present invention, the authentication device collectively performs the authentication processing, and thus an advanced authentication method can be performed without increasing processing loads in each vehicle-mounted control device. Accordingly, security of the vehicle-mounted network can be enhanced while reducing the processing loads in each vehicle-mounted control device.

### BRIEF DESCRIPTION OF DRAWINGS

FIG. 1 is a diagram illustrating a configuration of a vehicle-mounted network system 1000 according to a first embodiment.

FIG. 2 is a diagram illustrating an exemplary configuration of the vehicle-mounted network system 1000 according to a second embodiment.

FIG. 3 is a diagram illustrating another exemplary configuration of the vehicle-mounted network system 1000.

FIG. 4 is a sequence diagram illustrating a communication procedure between a target ECU 101, a rewrite device 102, and an authentication server 103.

FIG. 5 is a sequence diagram illustrating another communication procedure between the target ECU 101, the rewrite device 102, and the authentication server 103.

FIG. 6 is a diagram illustrating a processing sequence for confirming whether communication between the authentication server 103 and the target ECU 101 is established.

FIG. 7 is a diagram illustrating another processing sequence for confirming whether connection between the authentication server 103 and the target ECU 101 is established.

FIG. 8 is a diagram for explaining the operations when the authentication server 103 detects a spoofing device of the authentication server 103 on the vehicle-mounted network.

FIG. 9 is a diagram illustrating an exemplary processing flow performed when the target ECU 101 receives a session start request from the rewrite device 102 according to the first to fourth embodiments.

FIG. 10 is a diagram illustrating an exemplary network topology of a vehicle-mounted network provided in a recent typical sophisticated vehicle.

### DESCRIPTION OF EMBODIMENTS

### First Embodiment

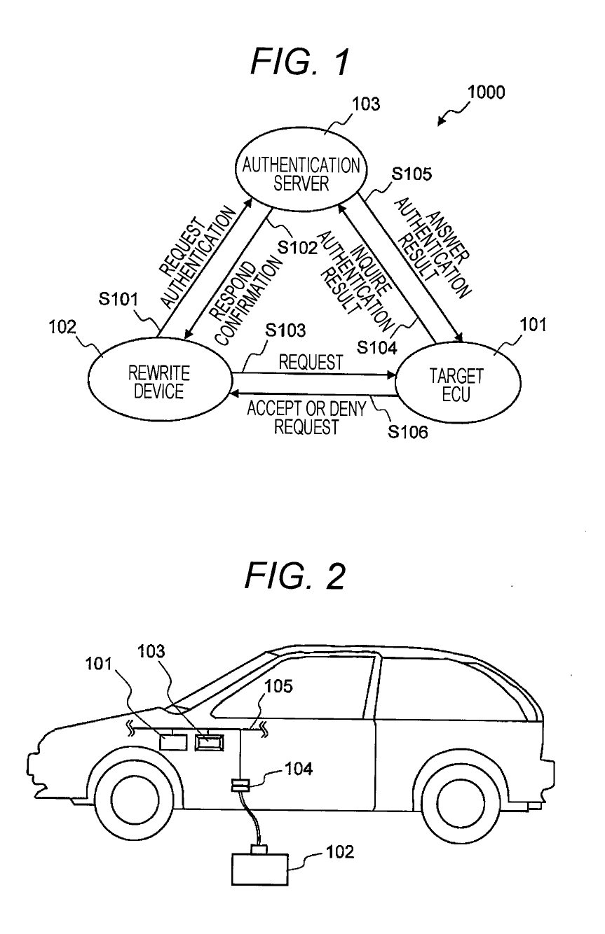

FIG. 1 is a diagram illustrating a configuration of a vehicle-mounted network system 1000 according to a first embodiment of the present invention. The vehicle-mounted network system 1000 is an in-vehicle network connecting ECUs for controlling the operation of the vehicle. Herein, only a target ECU 101 whose control program is to be rewritten is illustrated by way of example, but the number of ECUs connected to the vehicle-mounted network system 1000 is not limited thereto.

The vehicle-mounted network system 1000 is connected with the target ECU 101 and an authentication server 103 via a communication network. A rewrite device 102 is connected to the vehicle-mounted network system 1000 as needed in order to rewrite a control program stored in memory such as flash ROM by the target ECU 101 or to acquire internal data of the target ECU 101.

The authentication server 103 is capable of communicating with the target ECU 101 and the rewrite device 102 via the vehicle-mounted network. The authentication server 103 may be configured as one ECU or may be configured as any other communication device.

The rewrite device 102 needs to be previously authenticated by the authentication server 103 in order to perform the above-described processing on the target ECU 101. Authentication described herein is a processing of verifying whether or not the rewrite device 102 has an authority to perform the processing on the target ECU 101. A procedure in which the rewrite device 102 performs the processing on the target ECU 101 will be described below with reference to FIG. 1.

(FIG. 1: Step S101: Request Authentication)

Before issuing a program rewrite request or a data acquisition request to the target ECU 101, the rewrite device 102 requests the authentication server 103 to authenticate the rewrite device via the vehicle-mounted network. At this time, information specific to the rewrite device 102 such as identifier of the rewrite device 102 is transmitted together.

(FIG. 1: Step S102: Respond Confirmation)

When receiving the authentication request from the rewrite device 102, the authentication server 103 uses a predetermined authentication algorithm to authenticate the rewrite device 102. The authentication server 103 associates the identifier of the rewrite device 102 with the authentication result, and holds it on a storage device such as memory. When completing the authentication processing, the authentication server 103 transmits a confirmation response to the rewrite device 102.

(FIG. 1: Step S102: Confirmation Response: Supplement)

When transmitting the confirmation response to the rewrite device 102 in the present step, the authentication server 103 transmits the confirmation response without containing information on whether to authenticate the confirmation response. This is directed for protecting the authentication algorithm against the rewrite device 102 which tries authentication many times to break through the authentication processing.

(FIG. 1: Step S103: Request)

The rewrite device 102 transmits a request of rewriting the control program stored on the memory in the target ECU 101 or a request of acquiring the internal data of the target ECU 101 to the target ECU 101.

(FIG. 1: Step S104: Inquire Authentication Result)

The target ECU 101 inquires at the authentication server 103 as to whether the request transmission source in step S103 is an authorized terminal.

(FIG. 1: Step S105: Answer Authentication Result)

The authentication server 103 searches the authentication result of the rewrite device 102 held in step S102, and transmits the result to the target ECU 101.

(FIG. 1: Step S106: Accept or Deny Request)

When acquiring the answer of permitted authentication from the authentication server 103 in step S105, the target ECU 101 accepts the request received from the rewrite device 102 in step S103. When acquiring the answer of non-permitted authentication, the request received from the rewrite device 102 is denied. The target ECU 101 answers the rewrite device 102 as to whether to accept the request.

### First Embodiment

### Conclusion

As described above, in the vehicle-mounted network system 1000 according to the first embodiment, the authentication server 103 collectively authenticates the rewrite device 102 that issues a read request or a write request on the internal data of the ECU 101. Thereby, each ECU does not need to perform the authentication processing, and only needs to inquire at the authentication server 103 about the authentication result. Accordingly, the authentication processing can be performed without increasing processing loads in each ECU 101.

With the vehicle-mounted network system 1000 according to the first embodiment, the authentication processing can be collectively performed in the authentication server 103, and thus an advanced authentication technique such as public key encryption can be employed in the authentication server 103. Accordingly, the security of the vehicle-mounted network system 1000 can be enhanced without any restriction on the resource of each ECU 101. The hardware performance of each ECU 101 does not need to be enhanced for improving the security unlike before, and thus an increase in cost for enhanced security can be restricted.

Only the authentication server 103 performs the authentication processing in the vehicle-mounted network system 1000 according to the first embodiment. Thus, the technical information on the authentication processing does not need to be opened to external manufacturers, thereby preventing the security information leakage due to diffusion of the technical information. That is, typical vehicle-mounted ECUs, though with the same specification, may be ordered to a plurality of ECU manufacturers in parallel depending on vehicle type or delivery destination in order to disperse parts procurement risks or in order to optimize vehicle's total cost. With such a division form, in the conventional system in which each ECU 101 authenticates the rewrite device 102 as before, the technical information on the authentication processing needs to be opened to external ECU manufacturers. The present invention is advantageous in eliminating the need.

With the vehicle-mounted network system 1000 according to the first embodiment, the security level of the entire vehicle-mounted network depends on the security intensity of the authentication server 103. Thus, there is no risk that a vulnerable ECU lowers the security level of the entire vehicle-mounted network compared to when each ECU 101 performs the authentication processing as before.

With the vehicle-mounted network system 1000 according to the first embodiment, when the authentication function is updated if new vulnerability is found, the authentication algorithm of the authentication server 103 has only to be rewritten. When each ECU 101 performs the authentication processing as before, the authentication algorithm of each ECU 101 needs to be rewritten. Thus, the vehicle operation has to be stopped, which is inconvenient for the user. According to the present invention, the operation of the authentication server 103 has no relationship with the typical vehicle control, and thus the authentication algorithm can be updated without stopping the vehicle operation. For example, even when the vehicle travels, a security patch is distributed via a telephone network or Internet distribution, and the authentication algorithm can be rewritten. Thereby, the procedure of recalling the vehicles for updating the authentication algorithm is not required, and thus the vehicles do not need to be recovered for recall or service campaign, thereby rapidly performing the update work at low update cost.

### Second Embodiment

In a second embodiment, an exemplary specific configuration of the vehicle-mounted network system 1000 described in the first embodiment will be described.

FIG. 2 is a diagram illustrating the exemplary configuration of the vehicle-mounted network system 1000 according to the second embodiment. In FIG. 2, the target ECU 101 and the authentication server 103 are connected to a vehicle-mounted network 105 such as CAN, and are mounted inside the vehicle.

The rewrite device 102 is connected to the vehicle-mounted network 105 via a connection vehicle connector 104 provided on the outer surface of the vehicle. Thereby, the rewrite device 102 is connected to the target ECU 101 without taking the target ECU 101 to the outside of the vehicle, and performs the processing of rewriting the program held in the target ECU 101, or acquiring the internal data.

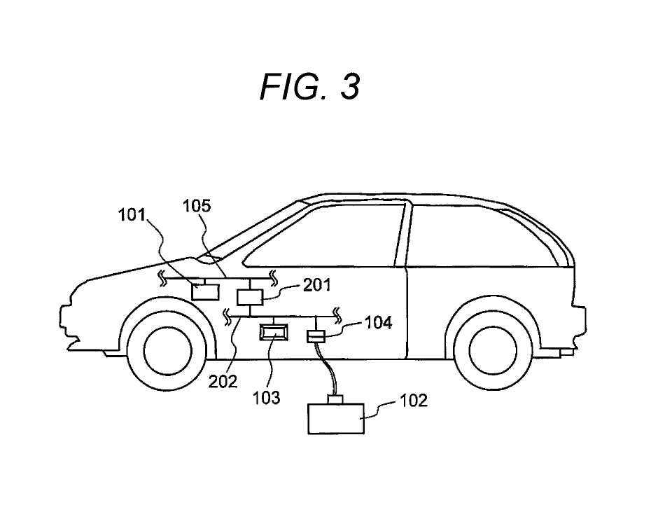

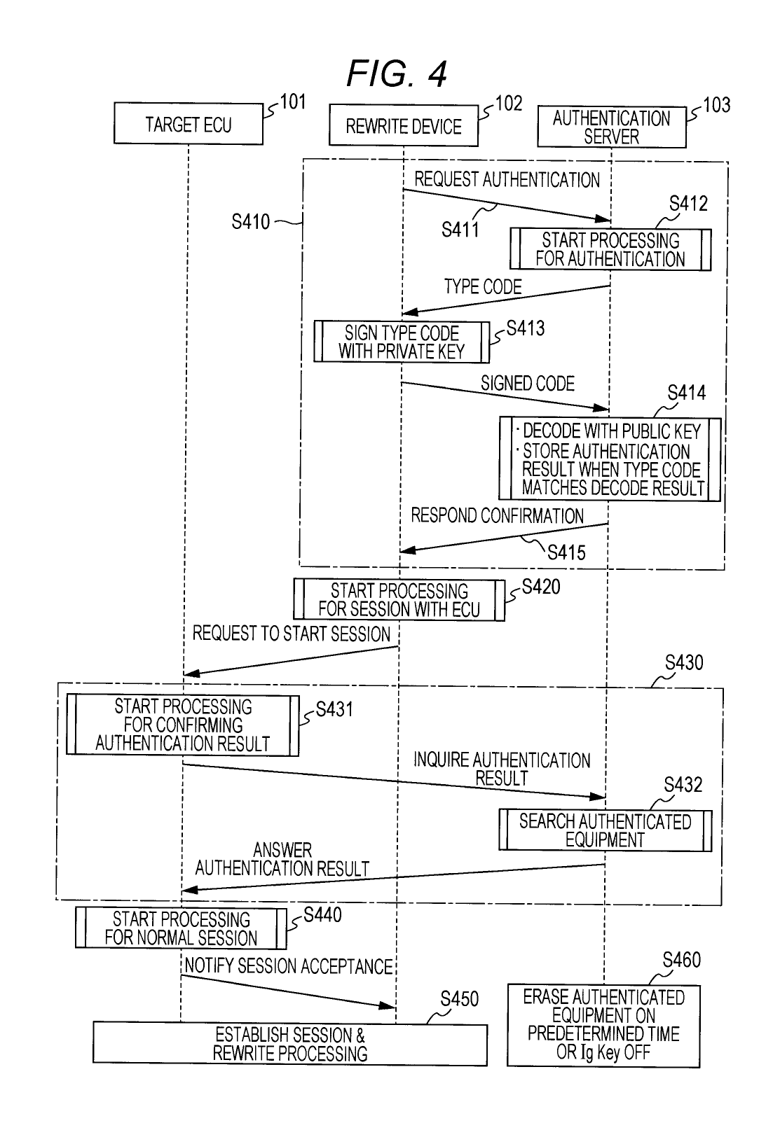

FIG. 3 is a diagram illustrating another exemplary configuration of the vehicle-mounted network system 1000. With the configuration illustrated in FIG. 3, a vehicle-mounted network 202 is newly provided in addition to the vehicle-mounted network 105, and the vehicle-mounted network 105 and the vehicle-mounted network 202 are connected with each other via a communication gateway 201.

The target ECU 101 is arranged under control of the vehicle-mounted network 105, and the rewrite device 102 and the authentication server 103 are arranged under control of the vehicle-mounted network 202. The former and the latter belong to different networks, respectively. The vehicle-mounted network 105 and the vehicle-mounted network 202 are electrically connected with each other via the communication gateway 201, and thus the devices can mutually communicate with each other.

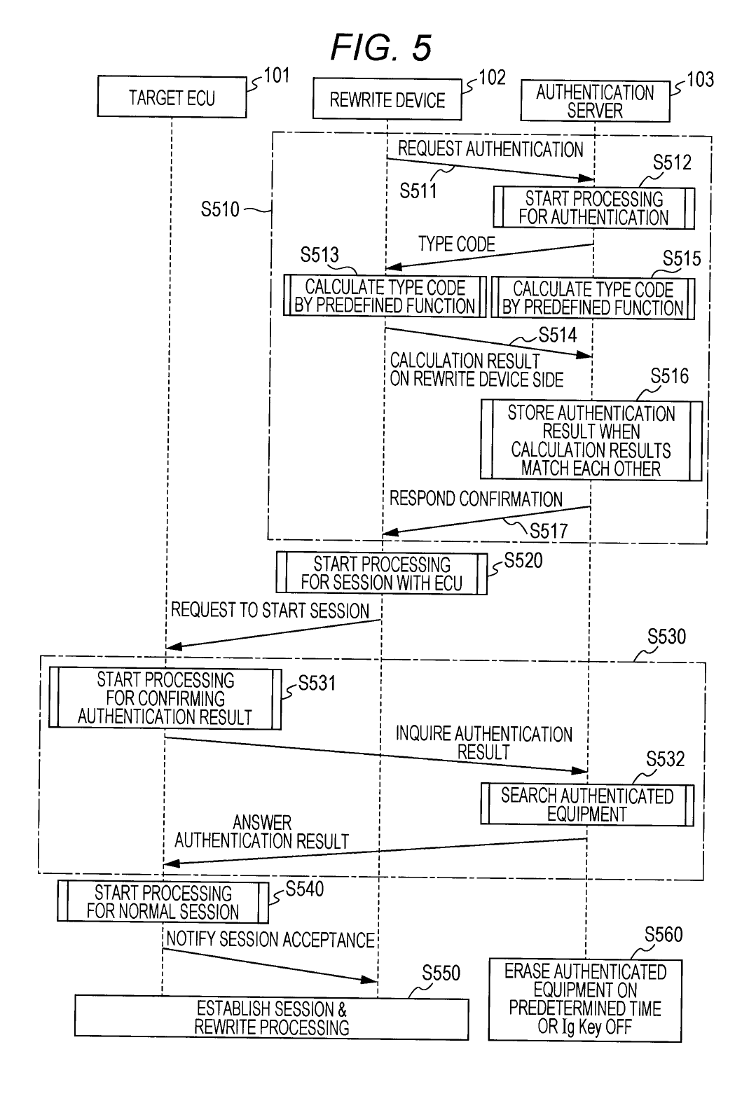

FIG. 4 is a sequence diagram illustrating a communication procedure between the target ECU 101, the rewrite device 102 and, the authentication server 103. It is assumed herein that the rewrite device 102 rewrites the program stored in the flash ROM in the target ECU 101 for addressing recall due to a failure in the program. Each step in FIG. 4 will be described below.

(FIG. 4: Step S410)

The rewrite device 102 and the authentication server 103 perform an authentication sequence S410 made of steps S411 to S415 described later. The authentication sequence S410 corresponds to steps S101 to S102 in FIG. 1. There is described herein a method for authenticating the rewrite device 102 by use of a digital signature based on a public key encryption system by way of example, but another authentication system may be employed. Incidentally, it is assumed that a pair of public key and private key is previously generated for the rewrite device 102 and the public key is previously distributed to the authentication device 103.

(FIG. 4: Step S411)

The rewrite device 102 requests the authentication server 103 to authenticate the rewrite device as an authorized terminal before issuing a read request or a write request to the target ECU 101, such as when being first connected to the vehicle-mounted network. At this time, an identification code of the rewrite device 102 (or similar information, as the case may be) is transmitted together to demonstrate the information specific to the rewrite device 102 to the authentication server 103.

(FIG. 4: Step S411: Supplement)

The authorized terminal herein is ensured in that the rewrite device 102 is authorized by the vehicle manufacturer and is not falsified and that the rewrite device 102 is not spoofed by other device.

(FIG. 4: Step S412)

The authentication server 103 performs an authentication start processing. Specifically, it generates a type code by a pseudorandom number, and returns it to the rewrite device 102. Further, it uses the identification code received from the rewrite device 102 in step S411 to specify the public key corresponding to the rewrite device 102.

(FIG. 4: Step S413)

The rewrite device 102 signs, by its private key, the type code received from the authentication server in step S412, and returns it as a signed code to the authentication server 103.

(FIG. 4: Step S414)

The authentication server 103 reads the public key specified in step S411, and uses it to decode the signed code received from the rewrite device 102 in step S413. The authentication server 103 compares the decode result with the type code transmitted to the rewrite device 102 in step S412, and when both match, determines that the rewrite device 102 is an authorized terminal. The authentication server 103 stores information that the rewrite device 102 is authenticated in an internal list of authenticated devices. When both do not match, the rewrite device 102 is not authenticated.

(FIG. 4: Step S415)

The authentication server 103 transmits, as a confirmation response, the fact that the authentication sequence S410 ends to the rewrite device 102. At this time, information on whether the rewrite device 102 is authenticated is not contained in the confirmation response. The reason is as described in step S102 in the first embodiment.

(FIG. 4: Step S420)

The rewrite device 102 transmits a session start request to the target ECU 101. The step corresponds to step S103 in FIG. 1. It is assumed that the session start request contains the identification code of the rewrite device 102.

(FIG. 4: Step S430)

The rewrite device 102 and the target ECU 101 perform an authentication inquiry sequence S430 made of steps S431 to S432 described later. The authentication inquiry sequence S430 corresponds to steps S104 to S105 in FIG. 1.

(FIG. 4: Step S431)

When receiving the session start request from the rewrite device 102, the target ECU 101 starts the processing of confirming the authentication result of the rewrite device 102. The target ECU 101 uses the identification code of the rewrite device 102 received in step S420 to inquire at the authentication server 103 about whether the rewrite device 102 is authenticated.

(FIG. 4: Step S432)

The authentication server 103 collates whether the identification code of the rewrite device 102 received in step S431 is registered in the list of authenticated devices. When the relevant identification code is found, the answer that the rewrite device 102 is authenticated is transmitted to the target ECU 101, and when not found, the answer that the rewrite device 102 is not authenticated is transmitted to the target ECU 101.

(FIG. 4: Step S440)

The target ECU 101 starts a normal session with the rewrite device 102. When receiving the response that the rewrite device 102 is authenticated in step S432, the target ECU 101 accepts the session start request from the rewrite device 102, and issues a session accept notification to the rewrite device 102. When receiving the response that the rewrite device 102 is not authenticated in step S432, the session start request from the rewrite device 102 is denied. For example, the session start request is ignored and no response is made to the rewrite device 102.

(FIG. 4: Step S450)

As a result of step S440, a session between the rewrite device 102 and the target ECU 101 is established. The rewrite device 102 performs the processings of rewriting the program held in the target ECU 101, or acquiring the internal data.

(FIG. 4: Step S460)

After normally completing the authentication sequence S410 and registering the rewrite device 102 in the list of authenticated devices, the authentication server 103 holds the contents of the list of authenticated devices as it is in preparation for an inquiry from the target ECU 101. The authentication server 103 discards the old list of authenticated devices based on a reference that the list of authenticated devices is held only during one driving cycle, or that the list of authenticated devices is held until a predetermined time elapses, or that the list of authenticated devices is held until the ignition key of the vehicle is turned off.

(FIG. 4: Step S460: Supplement)

The driving cycle is a concept presented in the vehicle self-diagnosis technique such as OBD II (On-Board Diagnostics, II generation, ISO-9141-2). With the technique, the driving cycle indicates a period containing one each of an engine start (except a start subsequent to engine automatic stop in an idling stop vehicle), a travelling state, and an engine stop state (except engine automatic stop in an idling stop vehicle).

FIG. 5 is a sequence diagram illustrating another communication procedure between the target ECU 101, the rewrite device 102, and the authentication server 103. Unlike FIG. 4, an authentication sequence S510 using an one-time password in a challenge and response system is employed instead of the authentication sequence S410. Each step in FIG. 5 will be described below mainly based on differences from FIG. 4.

(FIG. 5: Step S510)

The rewrite device 102 and the authentication server 103 perform the authentication sequence S510 made of steps S511 to S517 described later. It is assumed that a predefined function used in steps S513 to S515 described later is previously shared between the rewrite device 102 and the authentication device 103.

(FIG. 5: Step S511)

The present step is the same as step S411 in FIG. 4.

(FIG. 5: Step S512)

The authentication server 103 performs the authentication start processing. Specifically, it generates a type code by a pseudorandom number, and returns it to the rewrite device 102. Further, it uses the identification code received from the rewrite device 102 in step S511 to previously specify the predefined function corresponding to the rewrite device 102.

(FIG. 5: Steps S513 to S514)

The rewrite device 102 applies the type code received in step S512 to the predefined function thereby to calculate a calculation result (S513). The rewrite device 102 transmits the calculation result to the authentication server 103 (S514).

(FIG. 5: Step S515)

The authentication server 103 reads the predefined function specified in step S512, and applies the same code as transmitted to the rewrite device 102 in step S515 to the predefined function thereby to calculate a calculation result.

(FIG. 5: Step S516)

The authentication server 103 compares the calculation result received from the rewrite device 102 in step S514 with the calculation result calculated in step S515. When both match, the rewrite device 102 is determined as an authorized terminal. The authentication server 103 stores information that the rewrite device 102 is authenticated in the internal list of authenticated devices. When both do not match, it is found that the rewrite device 102 is not authenticated.

(FIG. 5: Step S517)

The authentication server 103 transmits, as a confirmation response, the fact that the authentication sequence S510 ends to the rewrite device 102. At this time, information on whether the rewrite device 102 is authenticated is not contained in the confirmation response. The reason is as described in step S102 in the first embodiment.

(FIG. 5: Steps S520 to S560)

The steps are the same as steps S420 to 460 in FIG. 4.

### Second Embodiment

### Conclusion

As described above, in the vehicle-mounted network system 1000 according to the second embodiment, the authentication server 103 can authenticate the rewrite device 102 by use of a digital signature based on a public key encryption system. The public key encryption system does not require the private key of the rewrite device 102 to be opened over the network and does not require the private key of the rewrite device 102 to be disclosed to the authentication server 103. Accordingly, the private key of the authorized rewrite device 102 can be kept confidential to the third parties, thereby enhancing the security of the vehicle-mounted network system 1000.

In the vehicle-mounted network system 1000 according to the second embodiment, the authentication server 103 can authenticate the rewrite device 102 by use of the one-time password in the challenge and response system. With the one-time password in the challenge and response system, the type code generated by the authentication server 103 changes each time, and thus the predefined function shared between the rewrite device 102 and the authentication server 103 is difficult to predict. Accordingly, the contents of the authentication processing can be kept confidential to the third parties, thereby enhancing the security of the vehicle-mounted network system 1000.

In the vehicle-mounted network system 1000 according to the second embodiment, the communication gateway 201 described with reference to FIG. 3 can serve as the authentication server 103. With such a configuration, when each of the authentication sequences S410 and S510 in FIGS. 4 and 5 fails, communication from the rewrite device 102 can be electrically disconnected from the vehicle-mounted network 105 to which the target ECU 101 belongs. With such a configuration, a so-called firewall (fire-protection wall) function is given to the communication gateway 201, and thus a risk of external invasion into the vehicle-mounted network is reduced, thereby further enhancing the security.

### Third Embodiment

There will be described, according to a third embodiment of the present invention, a structure in which the authentication server 103 is separated from the vehicle-mounted network system 1000 to prevent that the authentication processing is interfered or the authentication server 103 is spoofed by other device to perform an illegal authentication processing.

According to the first and second embodiments described above, the authentication processing is collectively performed in the authentication server 103 thereby to enhance the security level. However, when the security function of the authentication server 103 is interfered, the security of the entire vehicle-mounted network system 1000 can be jeopardized.

For example, it is assumed that inseparability between the target ECU 101 and the authentication server 103 is broken and the authentication server 103 is spoofed. That is, the authentication server 103 is removed from the vehicle-mounted network, or its connection to the vehicle-mounted network is interfered and the target ECU 101 is deceived by the malicious rewrite device 102 and a third device spoofing as the authentication server 103.

In order to avoid the above situation, the connection between the target ECU 101 and the authentication server 103 should be prevented from being disconnected, and the communication therebetween should be prevented from being interfered. The following three means may be employed for addressing the vulnerability.

(Countermeasure 1: Countermeasure at Target ECU 101 Side)

The target ECU 101 always monitors whether connection with the authentication server 103 is secured, and, when detecting that it is disconnected from the authentication server 103, the target ECU 101 denies a read request or a write request on the data inside the memory from the rewrite device 102 even if it receives the request.

(Countermeasure 2: Countermeasure at Authentication Server 103 Side)

The authentication server 103 always monitors whether connection with the target ECU 101 is secured, and, when detecting that it is disconnected from the target ECU 101, the authentication server 103 determines that the network configuration is illegally changed or that the authentication server 103 is removed from the vehicle-mounted network. At this time, the authentication server 103 stops the authentication processing, and denies the authentication for any request from the outside.

(Countermeasure 2: Countermeasure at Authentication Server 103 Side: Supplement)

Since the authentication server 103 typically monitors connection with a plurality of ECUs, the authentication server 103 can detect not only removal of a specific ECU but also a change in the entire network configuration. When an illegal change in the network configuration is detected with such a function, the fact may be notified to other ECUs or a failed function situation caused by the illegal change may be notified.

(Countermeasure 3: Originate Alarm)

When detecting a device spoofing as the authentication server 103 on the vehicle-mounted network, the authentication server 103 positively originates an alarm message such as forcible interruption notification to the target ECU in order to protect the target ECU to be illegally accessed.

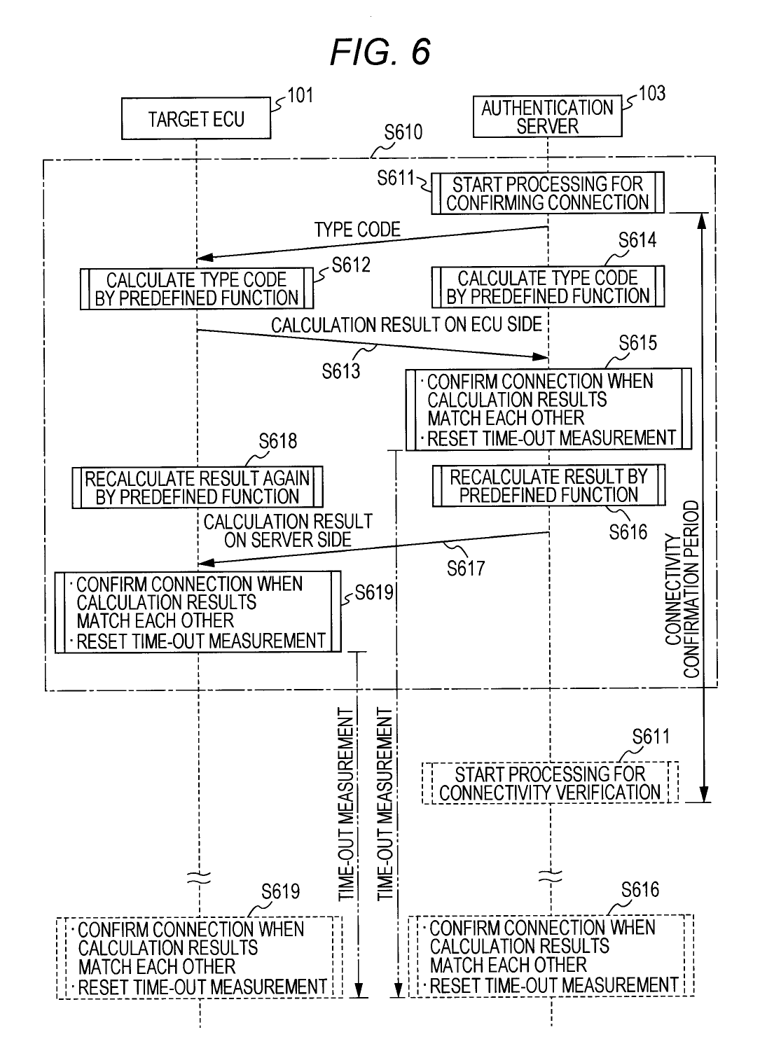

FIG. 6 is a diagram illustrating a processing sequence to confirm whether the connection between the authentication server 103 and the target ECU 101 is established. There is illustrated herein an example in which the authentication server 103 confirms the connection. In the processing sequence illustrated in FIG. 6, an one-time password based on the challenge and response system is used to confirm the connection. Each step illustrated in FIG. 6 will be described below.

(FIG. 6: Step S610)

The authentication server 103 and the target ECU 101 perform a connection confirmation sequence S610 made of steps S611 to S619 described later. Incidentally, it is assumed that the target ECU 101 and the authentication server 103 previously share a predefined function used in steps S612 to S614 described later.

(FIG. 6: Steps S611 to S614)

The authentication server 103 starts the connection confirmation processing. The steps are periodically started at predetermined time intervals, and thus the connection can be periodically confirmed. The specific processing procedure is the same as in steps S512 to S516, but is different in that the processing is performed between the authentication server 103 and the target ECU 101.

(FIG. 6: Step S615)

The authentication server 103 compares the calculation result in the target ECU 101 with the calculation result in the authentication server 103. When both match, it is confirmed that the connection between the authentication server 103 and the target ECU 101 is established, and a timer for measuring timeout is reset. When both do not match, it is determined that the connection cannot be confirmed.

(FIG. 6: Step S615: Supplement 1)

Since the connection confirmation processing is periodically activated, when the connection between the target ECU 101 and the authentication server 103 is established, the connection therebetween should be confirmed in the same period. When a period in which the connection therebetween cannot be confirmed exceeds a predetermined timeout period, the authentication server 103 determines that both are disconnected from each other. When the connection therebetween is confirmed in the present step, the timer is reset for measuring a timeout period.

(FIG. 6: Step S615: Supplement 2)

When determining that the connection between the target ECU 101 and the authentication server 103 is disconnected, the authentication server 103 stops the authentication processing, and performs a protection means such as issuing an alarm that the network configuration is illegally changed.

(FIG. 6: Steps S616 to S618)

In order to cause the target ECU 101 to confirm that the connection between the target ECU 101 and the authentication server 103 is established, the authentication server 103 uses the calculation result obtained by applying the predefined function again to the calculation result obtained in step S614 to reversely perform the same processing as in steps S612 to S614.

(FIG. 6: Step S619)

The target ECU 101 compares the calculation result in the target ECU 101 with the calculation result in the authentication server 103. When both match, it is confirmed that the connection between the authentication server 103 and the target EU 101 is established, and the timer for measuring timeout is reset. When both do not match, it is assumed that the connection is not confirmed.

(FIG. 6: Step S619: Supplement)

When determining that the connection between the target ECU 101 and the authentication server 103 is disconnected, the target ECU 101 denies a read request or a write request on the data inside the memory from the rewrite device 102 even if it has received the same.

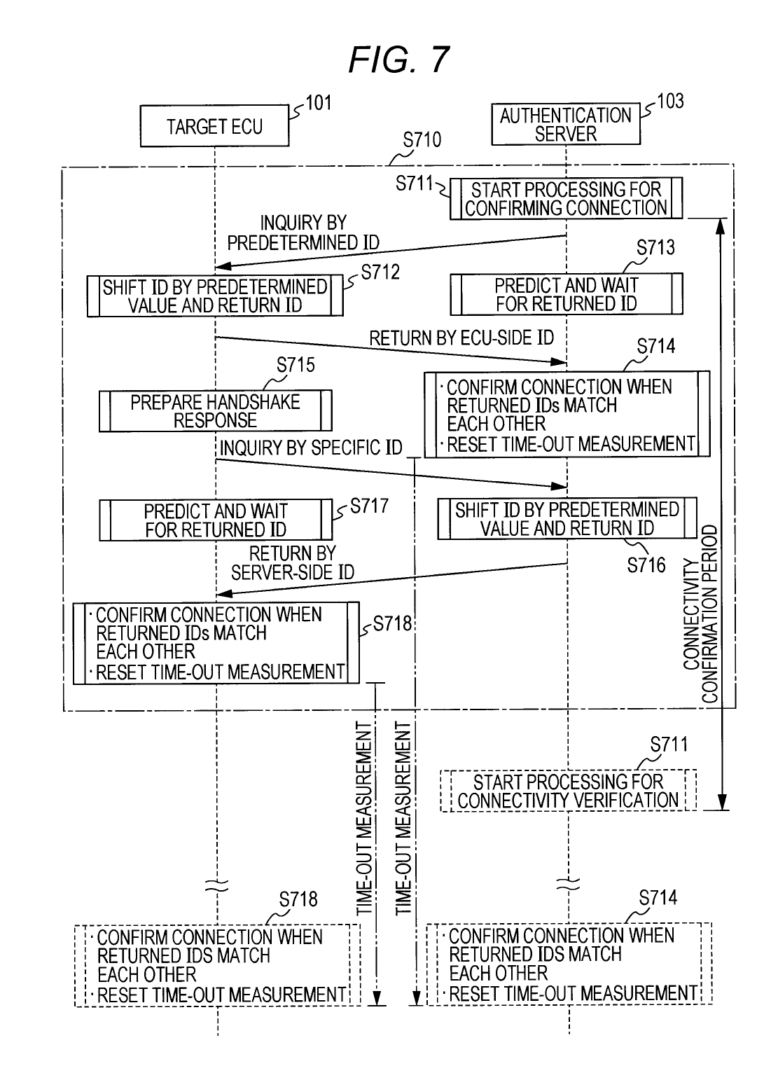

FIG. 7 is a diagram illustrating another processing sequence to confirm whether the connection between the authentication server 103 and the target ECU 101 is established. There is illustrated herein an example in which the authentication server 103 confirms the connection as in FIG. 6. In the processing sequence illustrated in FIG. 7, the connection is confirmed by use of a message ID hopping system.

The message ID hopping is a system in which a message having a predetermined ID value is transmitted to a destination and a result obtained by shifting the ID value by the same value on the transmission side and the reception side is mutually confirmed at both the transmission side and the reception side for mutual authentication. Each step illustrated in FIG. 7 will be described below.

(FIG. 7: Step S710)

The authentication server 103 and the target ECU 101 perform a connection confirmation sequence S710 made of steps S717 to S718 described later. It is assumed that a shift value used in steps S712 to S713 described later is previously shared between the target ECU 101 and the authentication device 103.

(FIG. 7: Step S711)

The authentication server 103 transmits a message having a predetermined ID value to the target ECU 101 thereby to originate an inquiry to the target ECU 101.

(FIG. 7: Step S712)

The target ECU 101 shifts the ID value received from the authentication server 103 by use of the shift value previously shared with the authentication server 103, and returns it as an ECU-side ID to the authentication server 103.

(FIG. 7: Step S713)

The authentication server 103 shifts the ID value transmitted to the target ECU 101 in step S711 by use of the shift value shared with the target ECU 101, and predicts an ECU-side ID to be returned from the target ECU 101.

(FIG. 7: Step S714)

The authentication server 103 compares the ECU-side ID transmitted from the target ECU 101 in step S712 with the ID predicted in step S713. When both match, it is confirmed that the connection between the authentication server 103 and the target ECU 101 is established, and the timer for measuring timeout is reset. When both do not match, it is assumed that the connection is not confirmed. The timeout is the same as in FIG. 6.

(FIG. 7: Step S714: Supplement)

When determining that the connection between the target ECU 101 and the authentication server 103 is disconnected, the authentication server 103 stops the authentication processing, and performs a protection means such as issuing an alarm that the network configuration is illegally changed.

(FIG. 7: Steps S715 to S717)

The target ECU 101 uses its holding predetermined ID value to reversely perform the same processing as in steps S711 to S713 in order to cause the target ECU 101 to confirm that the connection between the target ECU 101 and the authentication server 103 is established.

(FIG. 7: Step S718) The target ECU 101 compares the server-side ID returned by the authentication server 103 in step S716 with the ID predicted in step S717. When both match, it is confirmed that the connection between the authentication server 103 and the target ECU 101 is established, and the timer for measuring timeout is reset. When both do not match, it is assumed that the connection is not confirmed.

(FIG. 7: Step S718: Supplement)

When determining that the connection between the target ECU 101 and the authentication server 103 is disconnected, the target ECU 101 denies a read request or a write request on the data inside the memory from the rewrite device 102 even if it receives the request.

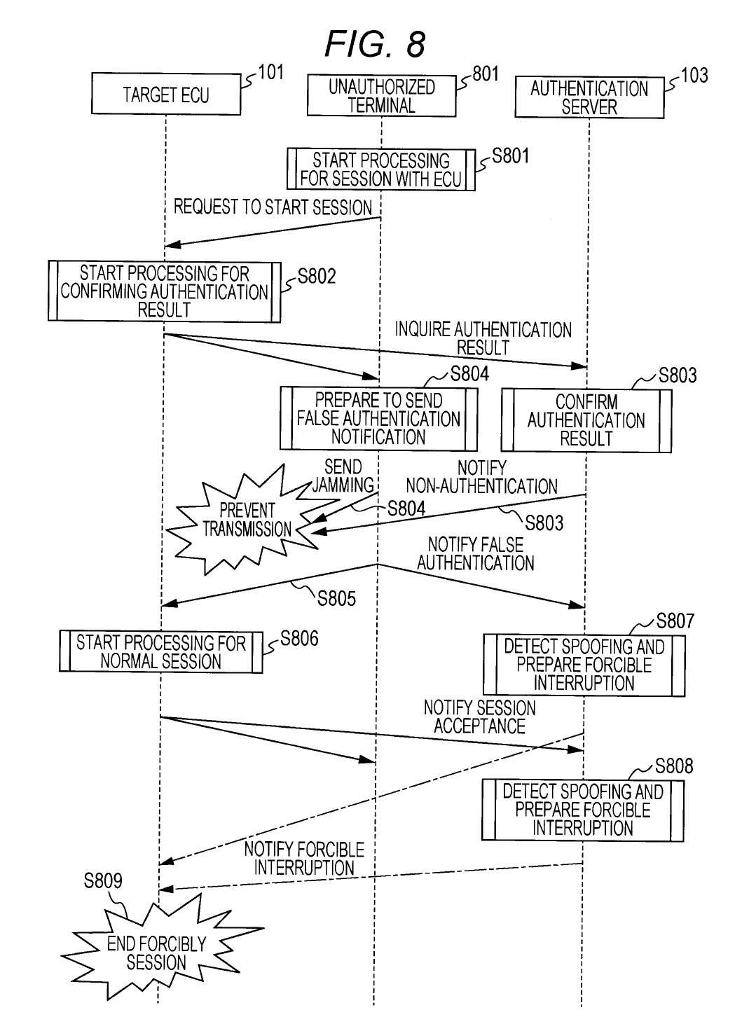

FIG. 8 is a diagram for explaining the operations when the authentication server 103 detects a device (unauthorized terminal 801) spoofing as the authentication server 103 on the vehicle-mounted network. Each step in FIG. 8 will be described below.

(FIG. 8: Step S801)

The unauthorized terminal 801 tries to directly access the target ECU 101 without making an authentication request to the authentication server 103. The unauthorized terminal 801 transmits a session start request to the target ECU 101.

(FIG. 8: Step S802)

When receiving the session start request from the unauthorized terminal 801, the target ECU 101 inquires at the authentication server 103 about whether the unauthorized terminal 801 is authenticated. At this time, since the vehicle-mounted network typically employs a bus configuration, the inquiry reaches each device connected to the vehicle-mounted network. Thus, both the authentication server 103 and the unauthorized terminal 801 can capture the inquiry from the target ECU 101.

(FIG. 8: Step S803)

The authentication server 103 notifies, to the target ECU 101, that the unauthorized terminal 801 is not authenticated.

(FIG. 8: Step S804)

The unauthorized terminal 801 starts to prepare to transmit a false authentication notification to the target ECU 101. The unauthorized terminal 801 prevents the non-authentication notification from reaching the target ECU 101 by sending a jamming signal or instantaneously stopping (not illustrated) the network connection between the target ECU 101 and the authentication server 103 in order to prevent the non-authentication notification transmitted from the authentication server 103 from reaching the target ECU 101.

(FIG. 8: Step S805)

The unauthorized terminal 801 transmits the false authentication notification to the target ECU 101 as if the authentication server 103 sent it. At this time, as in step S802, the false authentication notification also reaches the authentication server 103. Accordingly, the authentication server 103 can detect the presence of the unauthorized terminal 801.

(FIG. 8: Step S806)

The target ECU 101 receives the false authentication notification and starts a normal session with the unauthorized terminal 801. At this time, it originates a session accept notification containing an identification code of the unauthorized terminal 801.

(FIG. 8: Step S807)

When detecting the false authentication notification, the authentication server 103 notifies forcible interruption to the target ECU 101. Thus, it intends to prevent the unauthorized terminal 801 from illegally acquiring the data inside the target ECU 101 or illegally rewriting the program.

(FIG. 8: Step S808)

Since, even if the authentication server 103 cannot detect the false authentication notification in step S807, the target ECU 101 originates the session accept notification when starting the normal session with the unauthorized terminal 801, the presence of the unauthorized terminal 801 can be detected based on such a fact. Specifically, since the session accept notification contains the identification code of the unauthorized terminal 801, the authentication server 103 can detect a terminal directly accessing the target ECU 101 not via the authentication processing. When detecting the unauthorized terminal 801, the authentication server 103 performs the same processing as in step S807.

(FIG. 8: Step S809)

When receiving the forcible interruption notification, the target ECU 101 forcibly terminates the communication session with the unauthorized terminal 801.

### Third Embodiment

### Conclusion

As described above, with the vehicle-mounted network system 1000 according to the third embodiment, the authentication server 103 periodically confirms whether the communication with the target ECU 101 is established, and, when detecting that the connection is shut, the authentication server 103 stops the authentication processing. Thus, when the authentication server 103 is illegally separated from the vehicle-mounted network, the authentication processing cannot be performed, thereby preventing an unauthorized access.

With the vehicle-mounted network system 1000 according to the third embodiment, the target ECU 101 periodically confirms whether the communication with the authentication server 103 is established, and, when detecting that the connection is shut, the target ECU 101 denies a read request and a write request from the rewrite device 102. Thus, the same advantages as the above can be obtained.

In the vehicle-mounted network system 1000 according to the third embodiment, the connection between the authentication server 103 and the target ECU 101 is confirmed in the challenge and response system or the message ID shift system. Thus, the connection confirmation system therebetween can be concealed from the third party, and thus an unauthorized terminal trying to copy the connection confirmation procedure can be eliminated. The message ID shift amount may be previously shared between both nodes whose connection is to be confirmed, or may be secretly shared by previously inserting data for the shift amount in the first inquiry message.

With the vehicle-mounted network system 1000 according to the third embodiment, when detecting a device spoofing as the authentication server 103 on the vehicle-mounted network, the authentication server 103 transmits a forcible interruption notification to the target ECU 101. Thus, the unauthorized terminal 801 trying an unauthorized access can be eliminated without shutting the connection between the authentication server 103 and the target ECU 101.

There has been described in the third embodiment that the authentication server 103 confirms the connection, but the target ECU 101 may confirm. In either case, both the authentication server 103 and the target ECU 101 mutually confirm the connection thereby more accurately confirming the connection.

### Fourth Embodiment

According to the first to third embodiments, when authenticating the rewrite device 102, the authentication server 103 can issue a session ticket indicating the authority to read or write the data from or into the target ECU 101. The target ECU 101 may deny a read request or a write request on the rewrite device 102 not holding the session ticket having the authority even when the authentication server 103 has authenticated the rewrite device 102.

The session ticket is a communication identifier shared only between the authentication server 103 and the target ECU 101, and indicates that the rewrite device 102 is authenticated to have the authority to write into or read from the target ECU 101. Only when being authenticated by the authentication server 103, the rewrite device 102 can obtain the session ticket.

The session ticket according to the fourth embodiment is used together with the method according to the first to third embodiments, thereby further enhancing the security of the vehicle-mounted network system 1000.

### Fifth Embodiment

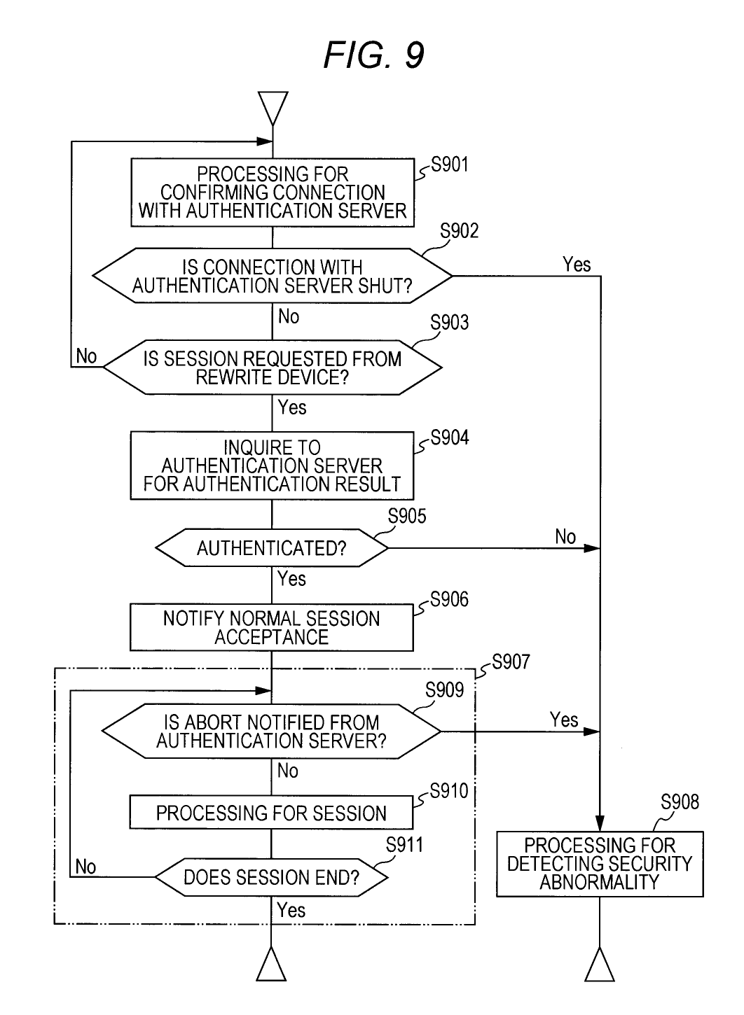

FIG. 9 is a diagram illustrating an exemplary processing flow performed when the target ECU 101 receives a session start request from the rewrite device 102 according to the first to fourth embodiments. Since the authentication processing is collectively performed in the authentication server 103 according to the present invention, the processings to be performed by the target ECU 101 are simplified. There is illustrated herein a case in which the rewrite device 102 requests to rewrite the program stored in the flash ROM inside the target ECU 101 by way of example. Each step in FIG. 9 will be described below.

(FIG. 9: Steps S901 to S902)

The target ECU 101 performs the connection confirmation processing illustrated in FIG. 6 or FIG. 7, and determines whether the connection with the authentication server 103 is established. When detecting that the connection with the authentication server 103 is shut, the target ECU 101 proceeds to step S908, and, when confirming that the connection is established, the target ECU 101 proceeds to step S903.

(FIG. 9: Step S903)

The target ECU 101 repeatedly performs steps S901 to S903 until receiving the session start request from the rewrite device 102, and, when receiving the session start request, the target ECU 101 proceeds to step S904.

(FIG. 9: Steps S904 to S906)

The target ECU 101 inquires at the authentication server 103 about the authentication result of the rewrite device 102. When the rewrite device is authenticated, the processing proceeds to step S906 to start a normal session with the rewrite device 102 and to originate a session accept notification. When the rewrite device is not authenticated, the processing proceeds to step S908.

(FIG. 9: Step S907)

The target ECU 101 starts a procedure of processing the write request from the rewrite device 102. When receiving the session accept notification in step S906, the authentication server 103 can recognize that the target ECU 101 has started to process the write request. Since other ECU cannot make a response even if it tries to communicate with the target ECU 101 while the target ECU 101 is performing the processing, the authentication server 103 may notify that the target ECU 101 is currently busy to other ECUs in broadcast.

(FIG. 9: Step S908)

The target ECU 101 determines that a security abnormality occurs in the vehicle-mounted network system 1000, and forcibly terminates the write request from the rewrite device 102. When having not received the write request, it prohibits subsequent receiving.

(FIG. 9: Step S909)

Also after starting step S907, the target ECU 101 periodically checks a forcible interruption notification (abort notification) from the authentication server 103. If an abort notification is made, the processing is skipped to step S908 to forcibly terminate the write request. This corresponds to step S809 in FIG. 8. If an abort notification is not made, the processing proceeds to step S910.

(FIG. 9: Steps S910 to S911)

The target ECU 101 processes the write request from the rewrite device 102 per predetermined processing.

When the write request is entirely processed, the processing flow ends, and when it remains, the processing returns to step S909 to repeat the same processing.

### Fifth Embodiment

### Conclusion

In step S907, it is assumed that the target ECU 101 has rewritten the data inside the flash ROM. Since the control program used for rewriting the data inside the flash ROM cannot be left in the flash ROM, and thus the program needs to be temporarily developed into a nonvolatile memory such as RAM. In a typical microcomputer, the capacity of the RAM is much smaller than that of the flash ROM, and thus an advanced authentication program or security monitoring program cannot be loaded together with the rewrite program.

When data is written into the flash ROM, a predetermined quantity of electric charges needs to be applied to the memory cells in the flash ROM, which is performed in a time modulation manner by the control program. Thus, the processing in step S907 needs to be strictly completed within a scheduled time due to such strict time restriction.

Thus, in order to alleviate the processing loads of the target ECU 101 in step S907 only for the write processing, it is useful that the authentication procedure, and the security monitoring procedure after the session starts are taken over to the authentication server 103.

### Sixth Embodiment

The method for rewriting the program provided in the target ECU 101 has been described in the first to fifth embodiments, but the program held in the authentication server 103 can be rewritten by use of the same method. Thereby, the authentication algorithm is updated to be more advanced thereby to enhance the security level. The authentication processing can be updated without rewriting the program of each ECU, which is advantageous in terms of cost.

The function of the authentication server 103 has no relationship with the normal control operation of each ECU, and thus it is advantageous that only the authentication algorithm can be rewritten without stopping the vehicle-mounted network or stopping the vehicle operation.

The processing of rewriting the program of the authentication server 103 can be performed by the rewrite device 102 as in the first to fifth embodiments. The authentication processing in this case has no relationship with the target ECU 101, and is only between the authentication server 103 and the rewrite device 102.

### Seventh Embodiment

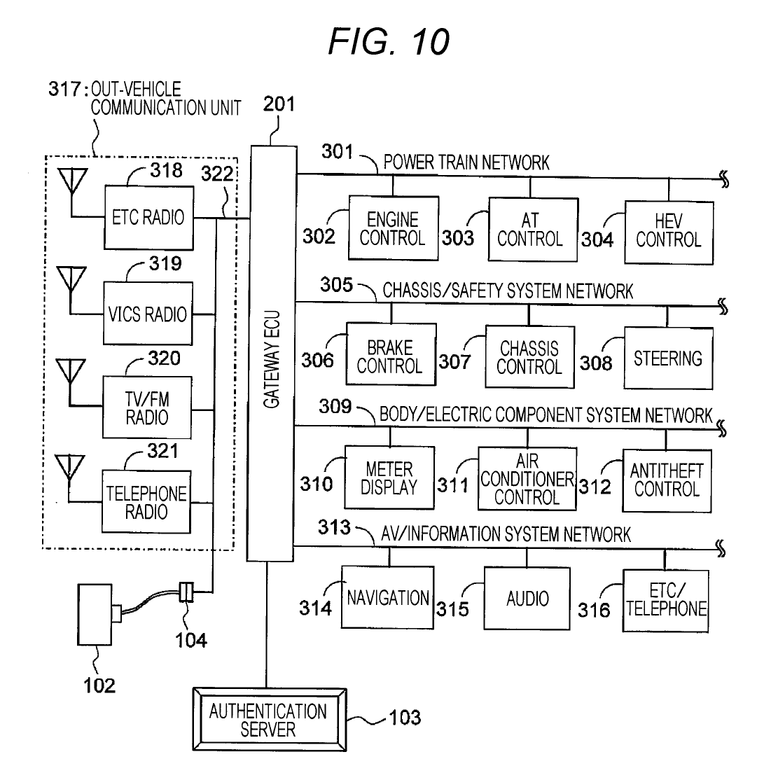

FIG. 10 is a diagram illustrating an exemplary network topology of the vehicle-mounted network provided in a recent representative sophisticated vehicle. The configurations and operations of the authentication server 103, the gateway device 201 and each ECU are the same as those in the first to sixth embodiments.

In FIG. 10, four network groups are mounted, and each network is organized by the communication gateway (gateway ECU) 201 described in FIG. 3. In FIG. 10, a star type network arrangement is employed about the gateway ECU 201, but a plurality of gateway ECUs 201 may be provided to employ a cascade connection form.

The vehicle-mounted network illustrated in FIG. 10 is mounted with a power train network 301, a chassis/safety system network 305, a body/electric component system network 309, and an AV/information system network 313.

Under control of the power train network 301, an engine control ECU 302, an AT (Automatic Transmission) control ECU 303, and a HEV (Hybrid Electric Vehicle) control ECU 304 are connected. Under control of the chassis/safety system network 305, a brake control ECU 306, a chassis control ECU 307, and a steering control ECU 308 are connected. Under control of the body/electric component system network 309, a meter display ECU 310, an air conditioner control ECU 311, and an antitheft control ECU 312 are connected. Under control of the AV/information system network 313, a navigation ECU 314, an audio ECU 315, and an ETC/phone ECU 316 are connected.

An out-vehicle communication unit 317 is connected to the gateway ECU 201 via an out-vehicle information network 322 in order to exchange information between the vehicle and the outside. The out-vehicle communication unit 317 is connected with an ETC radio 318, a VICS (Vehicle Information and Communication System) radio 319, a TV/FM radio 320, and a telephone radio 321.

The rewrite device 102 is configured to connect as one node of the out-vehicle information network 322 via the connection vehicle connector 104 provided in the vehicle. Instead, it may be solely connected to other networks (the power train network 301, the chassis/safety system network 305, the body/electric component system network 309, and the AV/information system network 313) or the gateway ECU 201. That is, an electric signal is only required to reach the target ECU directly or via the gateway ECU 201 irrespective of the mechanical arrangement.

The data or program inside a specific vehicle-mounted ECU may be rewritten from the outside via the telephone radio 321. In this case, the same method as in the first to sixth embodiments may be used for authenticating the device issuing the write request to the vehicle-mounted ECU via a telephone.

The method for rewriting the software of the ECU via a telephone network or Internet is important in lowering its cost for addressing a failure such as recall, and is expected to be usual in the future. Also in this case, the technique disclosed in the present invention can prevent unauthorized invasion into the vehicle-mounted network, and can ensure distribution and rewrite of authorized (protected for falsification) software.

The authentication server 103 is directly connected to the communication gateway ECU 201 in FIG. 10, but the authentication server 103 may be arbitrarily positioned over the network. That is, it may be directly connected to other network like the rewrite device 102 as far as electric signal connection can be secured.

The difference from the rewrite device 102 is that electric disconnection from the target ECU 101 (each ECU in FIG. 10) needs to be prevented. In terms of that, it is preferable that the communication gateway ECU 201 also serves as the authentication server 103. This is because if the authentication server 103 is removed, mutual communication over a plurality of vehicle-mounted networks cannot be made.

The invention made by the present inventors has been described above by way of the embodiments, but the present invention is not limited to the embodiments and may be variously modified without departing from the spirit of the invention.

All or part of the configurations, functions, and processing units may be realized in hardware such as integrated circuit, or may be realized in software such as the programs for realizing the respective functions executed by the processor. The information such as programs or table for realizing the respective functions may be stored in a storage device such as memory or hard disk, or a storage medium such as IC card or DVD.

### REFERENCE SIGNS LIST

101 Target ECU
102 Rewrite device
103 Authentication server
104 Connection vehicle connector
105 Vehicle-mounted network
201 Communication gateway
202 Vehicle-mounted network
301 Power train network
302 Engine control ECU
303 AT control ECU
304 HEV control ECU
305 Chassis/safety system network
306 Brake control ECU
307 Chassis control ECU
308 Steering control ECU
309 Body/electric component system network
310 Meter display ECU
311 Air conditioner control ECU
312 Antitheft control ECU
313 AV/information system network
314 Navigation ECU
315 Audio ECU
316 ETC/phone ECU
317 Out-vehicle communication unit
318 ETC radio
319 VICS radio
320 TV/FM radio
321 Telephone radio
1000 Vehicle-mounted network system

1. A vehicle-mounted network system comprising:
a vehicle-mounted control device provided with a memory for storing data; and
an authentication device that authenticates a communication device issuing a read request or a write request on data stored in the memory provided in the vehicle-mounted control device,
wherein the authentication device performs an authentication processing on the communication device and holds a result before the communication device issues the read request or the write request,
the vehicle-mounted control device inquires at the authentication device about the result of the authentication processing on the communication device when receiving the read request or the write request from the communication device,
accepts the read request or the write request when the authentication device authenticates the communication device, and
denies the read request or the write request when the authentication device does not authenticate the communication device.

2. The vehicle-mounted network system according to claim 1, wherein, when responding completion of the authentication processing to the communication device, the authentication device transmits the response without containing information on whether authentication is made in the response.

3. The vehicle-mounted network system according to claim 1, wherein the authentication device operates as a communication gateway for relaying communication between devices connected to the vehicle-mounted network system.

4. The vehicle-mounted network system according to claim 3, wherein the authentication device relays communication between the vehicle-mounted control device and the communication device, and
when the communication device is not authenticated in the authentication processing on the communication device, the authentication device does not relay communication from the communication device to the vehicle-mounted control device.

5. The vehicle-mounted network system according to claim 1, wherein the vehicle-mounted control device periodically confirms whether communication with the authentication device is established, and
when the connection with the authentication device is not confirmed, the vehicle-mounted control device denies the read request or the write request from the communication device.

6. The vehicle-mounted network system according to claim 1, wherein the authentication device periodically confirms whether connection with the vehicle-mounted control device is established, and
when the connection with the vehicle-mounted control device is not confirmed, the authentication device does not authenticate the communication device in the authentication processing on the communication device.

7. The vehicle-mounted network system according to claim 1, wherein the authentication device periodically confirms whether connection with the vehicle-mounted control device is established, and
when the connection with the vehicle-mounted control device is not confirmed, the authentication device originates an alarm indicating a fact.

8. The vehicle-mounted network system according to claim 1, wherein the authentication device monitors communication between the vehicle-mounted control device and the authentication device, and
when detecting an interference or block against the communication between the vehicle-mounted control device and the authentication device from another device or when detecting that another device spoofs as the authentication device, the authentication device originates an alarm indicating the fact.

9. The vehicle-mounted network system according to claim 1, wherein, when the vehicle-mounted control device and the communication device are in communication after the communication device is authenticated in the authentication processing, the authentication device notifies a fact to other devices connected to the vehicle-mounted network system.

10. The vehicle-mounted network system according to claim 1, wherein, when authenticating the communication device in the authentication processing, the authentication device distributes a communication identifier indicating the authentication to the communication device,
when receiving the read request or the write request from the communication device, the vehicle-mounted control device confirms whether the communication device holds the communication identifier,
accepts the read request or the write request when the communication device holds the communication identifier, and
denies the read request or the write request when the communication device does not hold the communication identifier.

11. The vehicle-mounted network system according to claim 1, wherein the authentication device is configured to update a processing procedure performed in the authentication processing.

12. The vehicle-mounted network system according to claim 1, wherein the authentication device performs the authentication processing by verifying a digital signature based on a public key encryption system.

13. The vehicle-mounted network system according to claim 1, wherein the authentication device performs the authentication processing in a challenge and response system.

14. The vehicle-mounted network system according to claim 5, wherein the vehicle-mounted control device uses a challenge and response system or a message ID hopping system to confirm whether connection with the authentication device is established.

15. The vehicle-mounted network system according to claim 6, wherein the authentication device uses a challenge and response system or a message ID hopping system to confirm whether connection with the vehicle-mounted control device is established.
